(19) United States
(12) Patent Application Publication
(10) Pub. No.: US 2026/0336611 A1
(43) Pub. Date: Oct. 29, 2026

(54) METHOD AND APPARATUS FOR MINIMIZING REAR COLLISION DAMAGE

(71) Applicants: HYUNDAI MOTOR COMPANY, Seoul (KR); KIA CORPORATION, Seoul (KR)

(72) Inventor: Dong Hoon Kang, Hwaseong-si (KR)

(73) Assignees: HYUNDAI MOTOR COMPANY, Seoul (KR); KIA CORPORATION, Seoul (KR)

(21) Appl. No.: 19/363,510

(22) Filed: Oct. 20, 2025

(30) Foreign Application Priority Data
Apr. 25, 2025 (KR) 10-2025-0054535

(51) Int. Cl. B60W 30/095

(52) U.S. Cl. CPC B60W 30/0953; B60W 30/0956; B60W 2520/10; B60W 2520/105; B60W 2540/043; B60W 2540/227; B60W 2552/30; B60W 2554/4041; B60W 2554/4042; B60W 2554/802

(57) ABSTRACT

A method for rear collision-avoidance assist (RCA) in a vehicle includes receiving current driving information of the vehicle and current driving information of a rear vehicle. The method also includes determining whether the vehicle and the rear vehicle are predicted to collide with each other within a preset threshold time, based on the current driving information of the vehicle and the current driving information of the rear vehicle. The method additionally includes determining a rear collision direction, based on seating positions including multiple rows of one or more passengers seated in the vehicle. The method also includes determining an acceleration amount of the vehicle to prevent a collision between the vehicle and the rear vehicle or to mitigate a rear impact amount, based on the current driving information of the vehicle.

### CROSS-REFERENCE TO RELATED APPLICATION

This application claims the benefit of and priority to Korean Patent Application No. 10-2025-0054535, filed on Apr. 25, 2025, the entire contents of which are hereby incorporated herein by reference.

### TECHNICAL FIELD

The present disclosure relates to a method and an apparatus for minimizing rear collision damage.

### BACKGROUND

The matters described in this Background section merely provide background information related to the present disclosure, and should not be taken as acknowledgement that the matters include prior art already known to those having ordinary skill in the art.

In the related art, driving safety operations of protecting drivers and passengers from vehicle collisions have been focused on frontal collisions and side collisions. In the related art, driving safety operations of responding to rear collisions have been fulfilled to respond post-collisions such as airbag deployment.

In a case of a rear collision of a vehicle, there is a possibility that persons sitting in back seats are more likely to suffer serious injury than persons sitting in a driver seat or a passenger seat. In addition, in many cases, children, disabled persons, and elderly persons who are vulnerable to impacts ride in the back seats.

### SUMMARY

Embodiments of the present disclosure provide a response method for minimizing collision damage before the rear collisions, in situations where the rear collisions are expected.

Embodiments of the present disclosure provide a method and an apparatus for avoiding a rear collision or minimizing rear collision damage and/or injury by controlling a driving direction and a driving speed of a vehicle when a rear collision is expected.

Aspects to be achieved by the present disclosure are not limited to the above-described aspects. Other aspects not described herein should be more clearly understood by those having ordinary skill in the art from the description below.

According to an embodiment of the present disclosure, a computer-implemented method for rear collision-avoidance assist (RCA) for preventing or minimizing rear collision damage of a vehicle is provided. The method includes receiving current driving information of the vehicle and current driving information of a rear vehicle obtained by using at least one sensor included in the vehicle. The current driving information of the vehicle includes a speed and acceleration of the vehicle. The current driving information of the rear vehicle includes i) a speed and acceleration of the rear vehicle and ii) a distance between the vehicle and the rear vehicle. The method also includes determining whether the vehicle and the rear vehicle are predicted to collide with each other within a preset threshold time, based on the current driving information of the vehicle and the current driving information of the rear vehicle. The method additionally includes determining a rear collision direction, based on seating positions including multiple rows of one or more passengers seated in the vehicle. The method also includes determining an acceleration amount of the vehicle to prevent a collision between the vehicle and the rear vehicle or to mitigate a rear impact amount, based on the current driving information of the vehicle.

According to another embodiment of the present disclosure, a device for preventing or minimizing rear collision damage of a vehicle is provided. The device includes at least one memory storing computer-readable instructions and at least one processor. The at least one processor is configured to execute the computer-readable instructions to: receive current driving information of the vehicle and current driving information of a rear vehicle obtained by using at least one sensor included in the vehicle, wherein the current driving information of the vehicle includes a speed and acceleration of the vehicle, and wherein the current driving information of the rear vehicle includes i) a speed and acceleration of the rear vehicle and ii) a distance between the vehicle and the rear vehicle; determine whether the vehicle and the rear vehicle are predicted to collide with each other within a preset threshold time, based on the current driving information of the vehicle and the current driving information of the rear vehicle; determine a rear collision direction, based on seating positions including multiple rows of one or more passengers seated in the vehicle; and determine an acceleration amount of the vehicle to prevent a collision between the vehicle and the rear vehicle or to mitigate a rear impact amount, based on the current driving information of the vehicle.

According to an embodiment of the present disclosure, when a rear collision is predicted, steering control and speed control are performed. Therefore, there is an advantageous effect of avoiding a rear collision or minimizing rear collision damage and/or injury.

According to an embodiment of the present disclosure, when a rear collision is predicted, a collision direction is determined in view of seating positions of passengers and driving stability. Therefore, there is an advantageous effect of minimizing rear collision damage and/or injury.

According to an embodiment of the present disclosure, when a vulnerable person is present as a passenger in a vehicle, a collision direction is determined in view of a seating position of the vulnerable person. Therefore, there is an advantageous effect of favorably protecting safety of the vulnerable person in a case of a rear collision.

According to an embodiment of the present disclosure, a collision point with a rear vehicle is adjusted through steering control, and rotation of a vehicle is induced in a case of a collision. Therefore, there is an advantageous effect of converting some of collision energy into rotational energy and reducing an impact amount applied to passengers in a case of a rear collision.

Advantageous effects of the present disclosure are not limited to the above-described advantageous effects. Other advantageous effects not described herein should be more clearly understood by those having ordinary skill in the art from the description below.

### BRIEF DESCRIPTION OF THE DRAWINGS

FIG. 1 is a block diagram schematically illustrating a Rear Collision-Avoidance Assist (RCA) device according to an embodiment of the present disclosure.

FIG. 2 is a flowchart for schematically describing a method for preventing or minimizing rear collision damage according to an embodiment of the present disclosure.

FIG. 3 is a diagram illustrating an example of a seating arrangement in a vehicle having three rows of seats.

FIGS. 4 and 5 are flowcharts for describing a process in which the RCA device determines a rear collision direction according to an embodiment of the present disclosure.

FIG. 6 is a table illustrating the rear collision direction determined based on the methods in FIGS. 4 and 5 when the RCA operation is set to Mode 1 according to an embodiment of the present disclosure.

FIGS. 7-11 are diagrams illustrating the rear collision direction determined in various example situations, based on a method according to an embodiment of the present disclosure.

FIG. 12 is a flowchart for describing a process in which the RCA device determines an acceleration amount of an ego vehicle according to an embodiment of the present disclosure.

FIGS. 13-15 are diagrams illustrating examples in which driving control is performed in various example situations according to embodiments of the present disclosure.

FIG. 16 is a block diagram schematically illustrating a computing device that may be used to implement a method or an apparatus according to embodiments of the present disclosure.

### DETAILED DESCRIPTION

Hereinafter, embodiments of the present disclosure are described in detail with reference to the accompanying drawings. In the following description, like reference numerals designate like elements even when the elements are shown in different drawings. Further, in the following description, where it was determined that a detailed description of known operations and configurations would obscure the gist of the present disclosure, the detailed description thereof has been omitted.

Additionally, various terms such as first, second, A, B, (a), (b), etc., are used solely to differentiate one component from the other components. These terms do not imply or suggest the substances, order, or sequence of the components. Throughout this specification, when it is said that a part ‘includes’ or ‘comprises’ a component, the part is meant to further include other components, not to exclude thereof unless specifically stated to the contrary. The terms such as ‘unit’, ‘module’, or the like refer to one or more units for processing at least one function or operation, which may be implemented by hardware, software, or a combination thereof.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

The following detailed description, together with the accompanying drawings, is intended to describe example embodiments of the present disclosure, and is not intended to represent the only embodiments in which the present disclosure may be practiced.

In the present disclosure, a Rear Collision-Avoidance Assist (RCA) operation refers to an operation of controlling steering and/or a speed of a vehicle to avoid a rear collision or to minimize a rear collision damage. The RCA operation includes rear-seat passenger protection for protecting passengers seated in seats other than a driver's seat and a front passenger seat, and vulnerable first protection for favorably protecting a vulnerable person in the passengers.

In the present disclosure, the “vulnerable person” refers to a person who is likely to suffer damage (e.g., injury) in the event of rear collision, such as a child, an elderly person, or a disabled person.

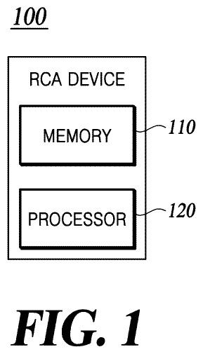

FIG. 1 is a block diagram schematically illustrating an RCA device (Rear Collision-Avoidance Assist device) according to an embodiment of the present disclosure.

An RCA device 100 includes a memory 110 and a processor 120. The RCA device 100 may be implemented in a form of an embedded device, a server, an electronic device in an autonomous driving system, and/or the like. All blocks illustrated in FIG. 1 are not essential configuration elements, and some blocks included in the RCA device 100 may be added, changed, or omitted in other embodiments. According to an embodiment, the configuration elements illustrated in FIG. 1 represent operationally distinct elements, and at least one of the configuration elements may be implemented in a form in which the configuration elements are integrated with each other in an actual physical environment.

The memory 110 stores data and commands or computer-readable instructions for an operation of the RCA device 100.

The memory 110 may store driving information of an ego vehicle, that is obtained by using at least one sensor included in the ego vehicle. The driving information of the ego vehicle may include one or more of a speed, acceleration, a steering angle, or a heading angle of the ego vehicle.

In addition, the memory 110 may store driving information of a rear vehicle, that is obtained by using at least one sensor included in the ego vehicle. The driving information of the rear vehicle may include one or more of a speed, acceleration, or a distance between the ego vehicle and the rear vehicle. In an embodiment, the distance between the ego vehicle and the rear vehicle means a distance between a rear bumper of the ego vehicle and a front bumper of the rear vehicle.

In addition, the memory 110 may store driving information of a front vehicle, that is obtained by using at least one sensor included in the ego vehicle. The driving information of the front vehicle may include one or more of a speed, acceleration, or a distance between the ego vehicle and the front vehicle. In an embodiment, the distance between the ego vehicle and the front vehicle means a distance between a front bumper of the ego vehicle and a rear bumper of the front vehicle.

The processor 120 controls an overall operation of the RCA device 100. The processor 120 may be implemented by one or more processors. The processor 120 may execute commands or computer-readable instructions stored in the memory 110.

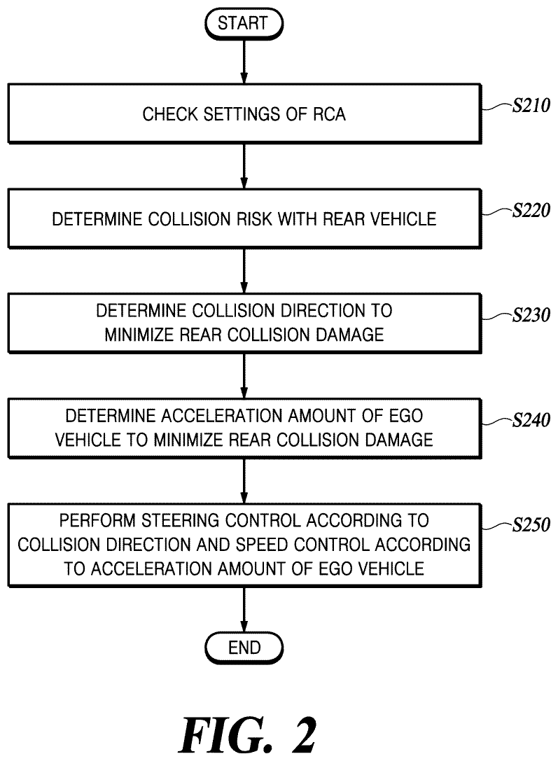

FIG. 2 is a flow chart for schematically describing a method for preventing or minimizing rear collision damage according to an embodiment of the present disclosure.

Referring to FIG. 2, in an operation S210, the RCA device 100 checks settings of the RCA operation to check whether the RCA operation is activated. When the RCA operation is activated, in an operation S220, the RCA device 100 determines a collision risk between the ego vehicle and the rear vehicle. When a collision between the ego vehicle and the rear vehicle is expected, in an operation S230, the RCA device 100 determines a collision direction in which the rear collision may be avoided or the rear collision damage may be minimized. In an operation S240, the RCA device 100 determines an acceleration amount of the ego vehicle which may avoid the rear collision or may minimize the rear collision damage. In an operation S250, the RCA device 100 or an autonomous driving system of the ego vehicle performs steering control and speed control, based on the collision direction and the acceleration amount of the ego vehicle.

Hereinafter, each of processes in S210 to S250, according to embodiments, is described in more detail.

In the operation S210, the RCA device 100 checks settings of the RCA operation to check whether the RCA operation is activated.

The RCA operation according to an embodiment of the present disclosure may be set to one of three modes. Mode 0 means that the RCA operation is deactivated. Accordingly, in Mode 0, both the rear-seat passenger protection and the vulnerable first protection are not applied. In Mode 1, the rear-seat passenger protection is applied, but the vulnerable first protection is not applied. In Mode 2, both the rear-seat passenger protection and the vulnerable first protection are applied.

In an embodiment of the present disclosure, a default setting of the RCA operation may be Mode 1. In this embodiment, unless a user changes the settings of the RCA operation, the rear-seat passenger protection operation is applied, and the vulnerable person first protection is not applied. However, the present disclosure is not limited thereto. For example, the default setting may be Mode 0 or Mode 2 in some embodiments.

In an embodiment of the present disclosure, a driver may set whether to apply the RCA operation. When the driver changes the settings of the RCA operation, for example through a user setting mode (USM), a changed setting value may be stored in the memory 110. The RCA device 100 may check the settings of the RCA operation stored in the memory 110 when a vehicle control system is turned on, and may apply the default setting when there is no stored setting value.

In an embodiment of the present disclosure, when a rear-seat passenger is present even when the RCA operation is deactivated by the driver, the RCA device 100 may change the settings of the RCA operation to the default setting for safety of the rear-seat passenger. In an embodiment, the RCA device 100 may notify the driver that the RCA operation is activated, and may guide the driver to manually reset the RCA operation when the driver wishes to deactivate the RCA operation.

In the operation S220, when the RCA operation is set to Mode 1 or Mode 2, the RCA device 100 determines a collision risk between an ego vehicle 10 and a rear vehicle 20.

The RCA device 100 may receive driving information of the ego vehicle 10 and driving information of the rear vehicle 20 from least one sensor included in the ego vehicle 10. The driving information of the ego vehicle 10 may include a speed, acceleration, and/or the like of the ego vehicle. In addition, the driving information of the rear vehicle 20 may include a speed, acceleration, and/or a distance between the ego vehicle 10 and the rear vehicle 20. In an embodiment, the distance between the ego vehicle and the rear vehicle means a distance between a rear bumper of the ego vehicle 10 and a front bumper of the rear vehicle 20.

When the rear vehicle 20 is recognized, the RCA device 100 may determine whether the rear vehicle and the ego vehicle are predicted to collide with each other within a preset threshold time, based on the driving information of the ego vehicle 10 and the driving information of the rear vehicle 20. The threshold time may mean a time required for an appropriate response when the distance between the ego vehicle 10 and the rear vehicle 20 becomes shorter. As an example, the threshold time may be 2 seconds, but is not limited thereto.

Mathematical Expression 1 is an example of an inequality for determining whether the ego vehicle 10 and the rear vehicle 20 are predicted to collide with each other within a preset critical time.

$$\frac{1}{2} {a}_{ego} \cdot {{T}_{THD}}^{2} + {v}_{ego} \cdot {T}_{THD} + {d}_{rear} \leq \frac{1}{2} {a}_{rear} \cdot {{T}_{THD}}^{2} + {v}_{rear} \cdot {T}_{THD} \qquad Mathematical Expression 1$$

In Mathematical Expression 1, T_{THD} is a critical time. In addition, v_{ego} and a_{ego} are respectively a current speed and acceleration of the ego vehicle 10, vᵣₑₐᵣ and aᵣₑₐᵣ are respectively a current speed and acceleration of the rear vehicle 20, and dᵣₑₐᵣ is the distance between the rear bumper of the ego vehicle 10 and the front bumper of the rear vehicle 20.

According to Mathematical Expression 1, when the rear bumper of the ego vehicle 10 touches the front bumper of the rear vehicle 20 within the critical time, it may be determined as the rear collision.

When Mathematical Expression 1 is satisfied, the RCA device 100 may operate the RCA operation since the collision between the ego vehicle 10 and the rear vehicle 20 is predicted.

In the operation S230, When the collision between the ego vehicle and the rear vehicle is predicted, the RCA device 100 determines a collision direction in which the rear collision may be avoided or the rear collision damage may be minimized. The RCA device 100 may determine the rear collision direction, based on passenger's seating positions and boarding information on a vulnerable person.

Hereinafter, in an example in which the ego vehicle 10 has 3 rows of seats, a method for the RCA device 100 to determine the rear collision direction, according to an embodiment, is described in more detail.

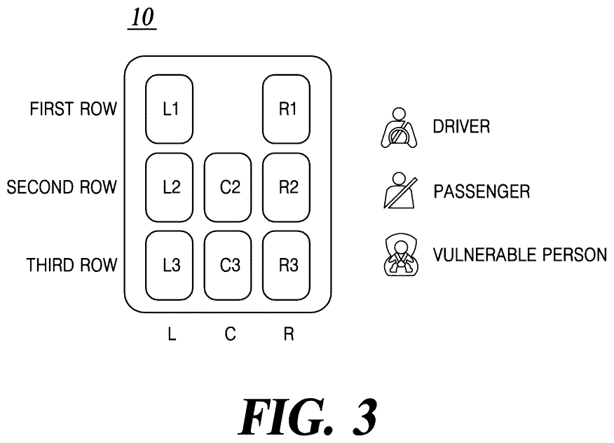

FIG. 3 is a diagram illustrating an example of a seating arrangement of the ego vehicle 10 having three rows of seats, according to an embodiment.

Referring to FIG. 3, in first row seats L1 and R1 of the ego vehicle 10, L1 is a driver's seat, and R1 is a front passenger's seat. Referring to FIG. 3, in second row seats L2, C2, and R2, L2 is a left seat of a middle row of the ego vehicle 10, C2 is a center seat of the middle row of the ego vehicle 10, and R2 is a right seat of the middle row of the ego vehicle 10. Referring to FIG. 3, in third row seats L3, C3, and R3, L3 is a left seat of a last row of the ego vehicle 10, C3 is a center seat of the last row of the ego vehicle 10, and R3 is a right seat of the last row of the ego vehicle 10.

In the drawings that follow, each of the driver, the passenger, and the vulnerable person who are seated in the ego vehicle 10 are represented by symbols illustrated on the right side in FIG. 3.

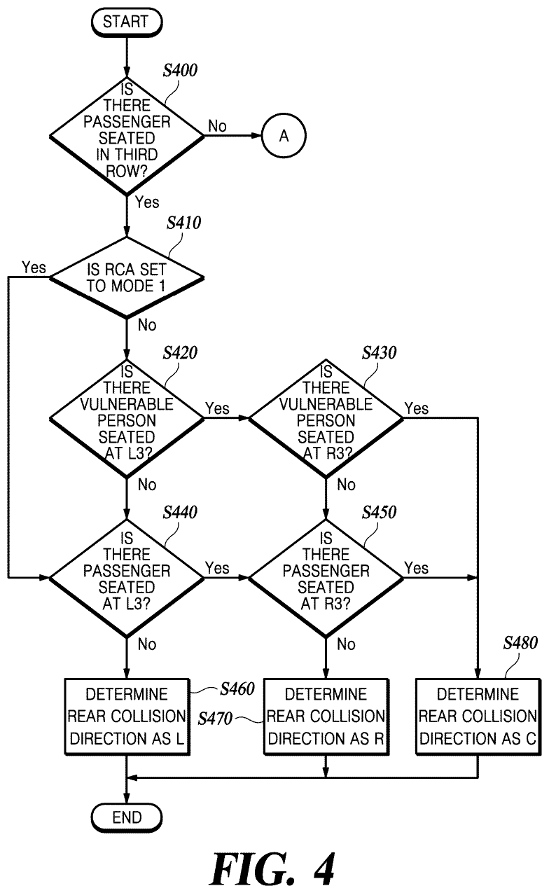

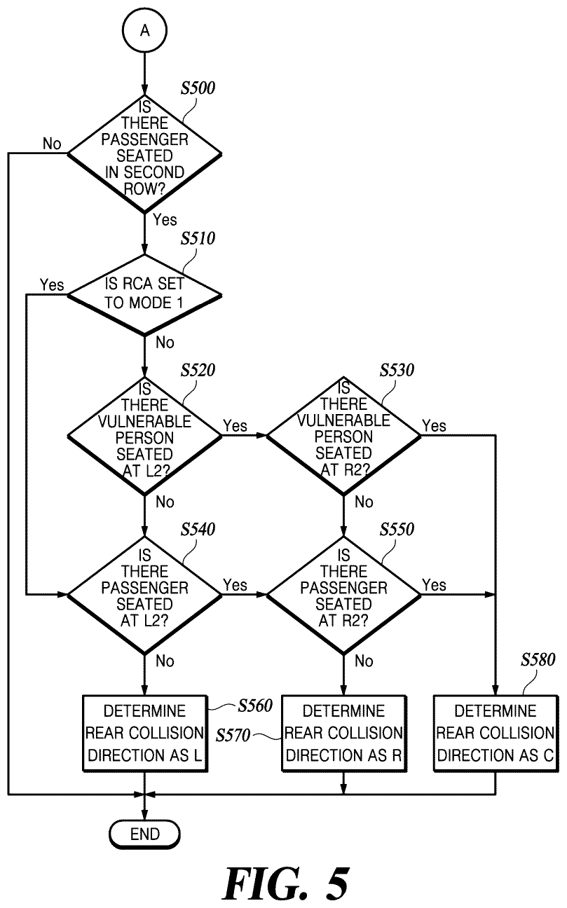

FIGS. 4 and 5 are flowcharts for describing a process in which the RCA device 100 determines the rear collision direction according to an embodiment of the present disclosure.

Referring to FIG. 4, in an operation S400, the RCA device 100 determines whether there is a passenger seated in the third row. In a case of the ego vehicle 10 having three rows of seats as illustrated in FIG. 3, the RCA device 100 favorably considers collision damage to a passenger seated in the third row, which is the last row, and determines the rear collision direction to minimize the damage to the passenger. The RCA device 100 may receive passenger seating position information and boarding information on the vulnerable person from at least one in-cabin camera (ICC) or in-cabin monitoring unit (ICMU) included in the ego vehicle 10.

When there is no passenger seated in the third row (NO in the operation S400), the rear collision direction is determined to minimize the collision damage to the passenger seated in the second row. This determination, according to an embodiment, is described in more detail below with reference to FIG. 5. When there is a passenger seated in the third row (YES in the operation S400), the RCA device 100 checks whether the RCA operation is set to Mode 1 in an operation S410.

When the RCA operation is set to Mode 1 (YES in the operation S410), the RCA device 100 checks whether there is a passenger seated at L3 (i.e., the left seat of the third row) in an operation S440. When the RCA operation is set to Mode 2 (NO in the operation S410), the RCA device 100 checks whether there is a passenger seated at L3 in an operation S420.

When there is no passenger seated at L3 (NO in the operation S420), the RCA device 100 checks whether there is a passenger seated at L3 in the operation S440. When there is a passenger seated at L3 (YES in the operation S420), the RCA device 100 checks whether there is a passenger seated at R3 (i.e., the right seat of the third row) in an operation S430.

When there is no passenger seated at R3 (NO in the operation S430), the RCA device 100 checks whether there is a passenger seated at R3 in an operation S450. When there is a passenger seated at R3 (YES in the operation S430), a center C of the rear bumper of the ego vehicle 10 is determined as the rear collision direction in an operation S480.

When there is no passenger seated at L3 (NO in the operation S440), the left side L of the rear bumper of the ego vehicle 10 is determined as the rear collision direction in an operation S460. When there is a passenger seated at L3 (YES in the operation S440), the RCA device 100 checks whether there is a passenger seated at R3 in an operation S450.

When there is no passenger seated at R3 (NO in the operation S450), the right side R of the rear bumper of the ego vehicle 10 is determined as the rear collision direction in an operation S470. When there is a passenger seated at R3 (YES in the operation S450), the center C of the rear bumper of the ego vehicle 10 is determined as the rear collision direction in an operation S480.

Referring to FIG. 5, when there is no passenger seated in the third row (NO in the operation S400), the RCA device 100 determines whether there is a passenger seated in the second row in an operation S500. The RCA device 100 may receive seating position information of the passengers seated in the second row and boarding information of the vulnerable person from at least one in-cabin camera (ICC) or the in-cabin monitoring unit (ICMU) included in the ego vehicle 10.

When there is no passenger seated in the second row (NO in the operation S500), the RCA device 100 completes the process of determining the rear collision direction. When there is a passenger seated in the second row (YES in the operation S500), the RCA device 100 checks whether the RCA operation is set to Mode 1 in an operation S510.

When the RCA operation is set to Mode 1 (YES in the operation S510), the RCA device 100 checks whether there is a passenger seated at L2 (i.e., the left seat of the second row) in an operation S540. When the RCA operation is set to Mode 2 (NO in the operation S510), the RCA device 100 checks whether there is a passenger seated at L2 in an operation S520.

When there is no passenger seated at L2 (NO in the operation S520), the RCA device 100 checks whether there is a passenger seated at L2 in an operation S540. When there is a passenger seated at L2 (YES in the operation S520), the RCA device 100 checks whether there is a passenger seated at R2 (i.e., the right seat of the second row) in an operation S530.

When there is no passenger seated at R2 (NO in the operation S530), the RCA device 100 checks whether there is a passenger seated at R2 in an operation S550. When there is a passenger seated at R2 (YES in the operation S530), the center C of the rear bumper of the ego vehicle 10 is determined as the rear collision direction in an operation S580.

When there is no passenger seated at L2 (NO in the operation S540), the left side L of the rear bumper of the ego vehicle 10 is determined as the rear collision direction in an operation S560. When there is a passenger seated at L2 (YES in the operation S540), the RCA device 100 checks whether there is a passenger seated at R2 in an operation S550.

When there is no passenger seated at R2 (NO in the operation S550), the right side R of the rear bumper of the ego vehicle 10 is determined as the rear collision direction in an operation S570. When there is a passenger seated at R2 (YES in the operation S550), the center C of the rear bumper of the ego vehicle 10 is determined as the rear collision direction in an operation S580.

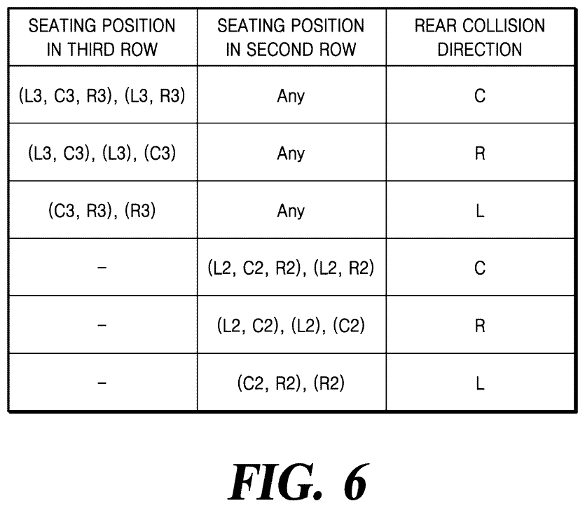

FIG. 6 is a table illustrating the rear collision direction determined based on the method in FIGS. 4 and 5 when the RCA operation is set to Mode 1 according to an embodiment. In the table in FIG. 6, parentheses indicate positions of the seats where the passenger is seated. For example, (L3, R3) indicates that there are passengers seated at the left seat L3 and the right seat R3 of the third row.

Referring to rows 1 to 3 in the table in FIG. 6, when there is a passenger seated in the third row, the rear collision direction is determined based on the position of the passenger seated in the third row, regardless of the position of the passenger seated in the second row. Referring to Rows 4 to 6 in the table in FIG. 6, when there is no passenger seated in the third row, the rear collision direction is determined based on the position of the passenger seated in the second row.

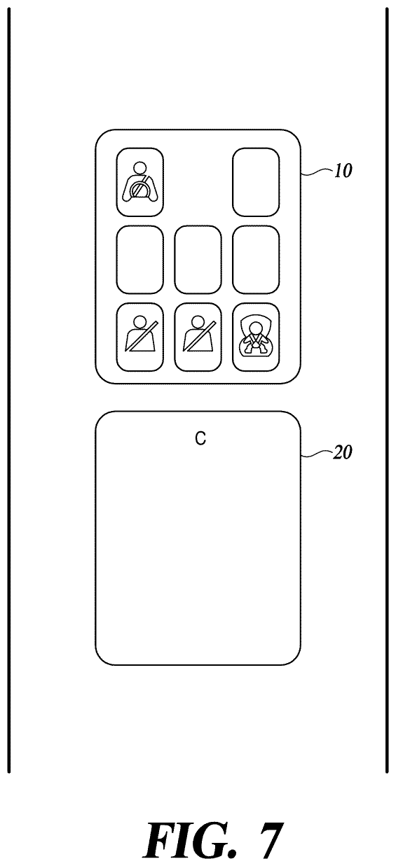

FIGS. 7 to 11 are diagrams illustrating the rear collision direction determined in various example situations, based on a method according to an embodiment of the present disclosure.

FIG. 7 is a diagram illustrating a case where the passengers are seated at L3 and C3 of the ego vehicle 10 and the vulnerable person is seated at R3 in a state where the RCA operation is set to Mode 1. Referring to FIG. 7, since the passengers are seated at all seats of the third row, the rear collision direction is determined as the center C of the rear bumper C.

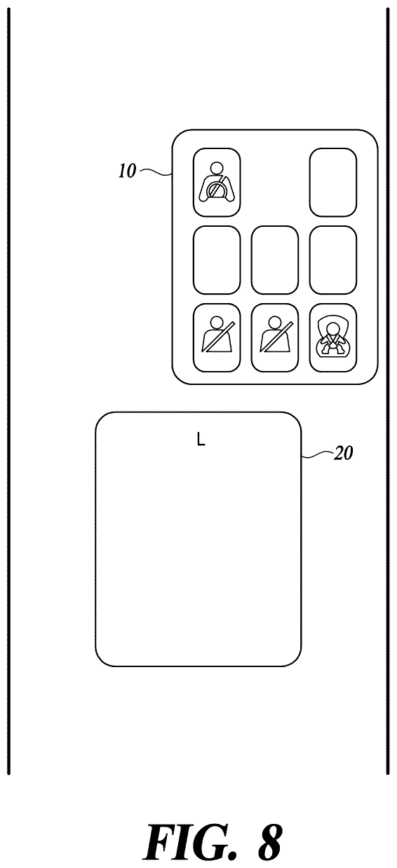

FIG. 8 is a diagram illustrating a case where passengers are seated at L3 and C3 of the ego vehicle 10 and a vulnerable person is seated at R3 in a state where the RCA operation is set to Mode 2. Referring to FIG. 8, since the vulnerable person is seated at R3, the rear collision direction is determined to the left side L of the rear bumper in order to protect the vulnerable person.

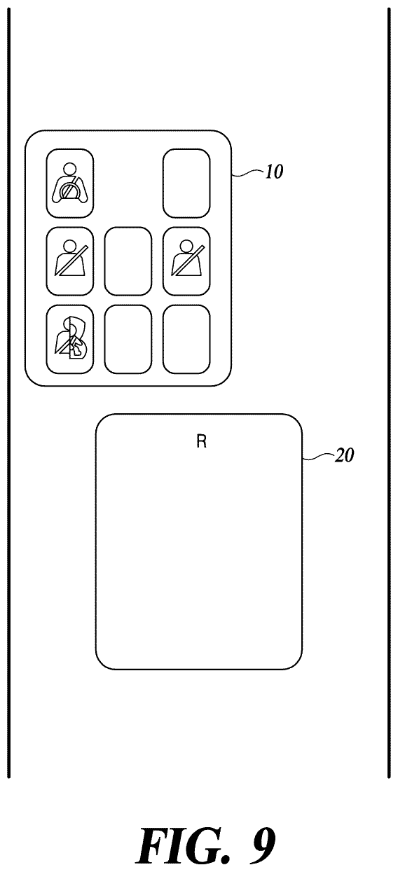

FIG. 9 is a diagram illustrating a case where the passenger or the vulnerable person is seated at L3 of the ego vehicle 10 and passengers are seated at L2 and R2 in a state where the RCA operation is set to Mode 1 or Mode 2. When there is one passenger or one vulnerable person seated in the last row (i.e., the third row), the rear collision direction is determined regardless of the settings of the RCA operation since the passenger or the vulnerable person is preferentially protected. Therefore, in FIG. 9, the rear collision directions are all determined to the right side R of the rear bumper regardless of the settings of the RCA operation.

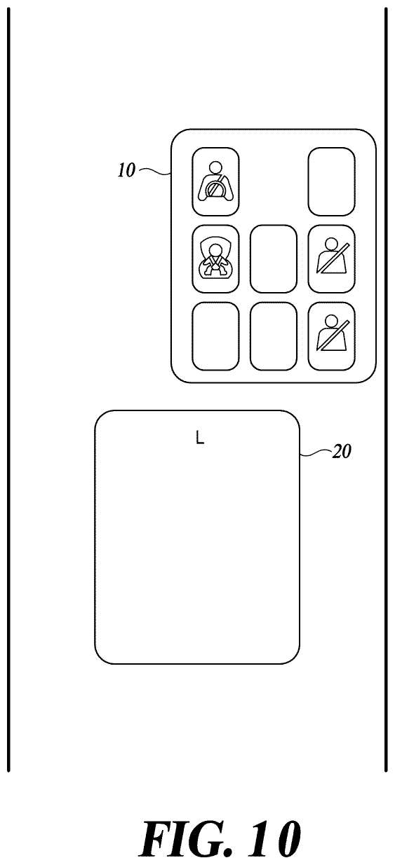

FIG. 10 is a diagram illustrating a case where the passengers are seated at R2 and R3 of the ego vehicle 10 and the vulnerable person is seated at L2 in a state where the RCA operation is set to Mode 1 or Mode 2. In an embodiment of the present disclosure, the rear collision direction is determined by preferentially consider the passenger or the vulnerable person seated in the last row (i.e., the third row) who is likely to suffer great damage in the event of the rear collision. Therefore, even when there is the vulnerable person seated at L2, which is the second row, the rear collision direction is determined to the left side L of the rear bumper regardless of the settings of the RCA operation.

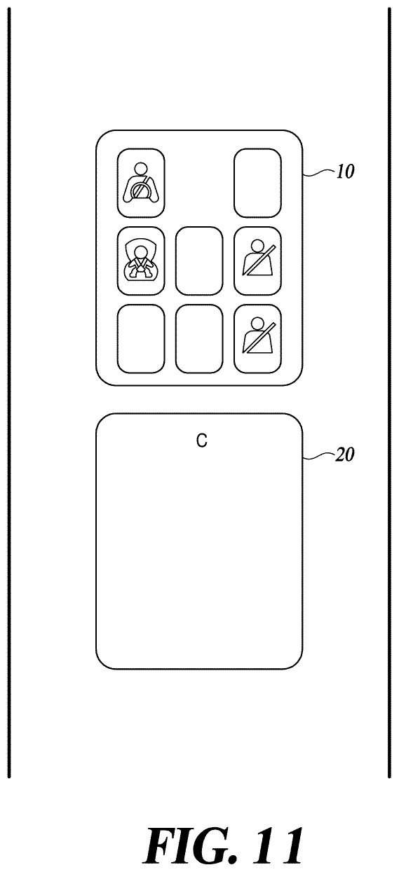

FIG. 11 is a diagram illustrating a case where the passengers are seated at R2 and R3 of the ego vehicle 10, and the vulnerable person is seated at L2 in an additional embodiment of the present disclosure. In the additional embodiment of the present disclosure, the RCA operation may be set to additional Mode 3. In Mode 3, the rear collision direction is determined to reduce collision damage to the vulnerable person regardless of the position of the seat at which the vulnerable person is seated. More specifically, the rear collision direction is preferentially determined based on the positions of the vulnerable person and the passenger seated in the last row. When it is difficult to protect all of the vulnerable person and the passenger seated in the last row, the rear collision direction is determined to minimize the collision damage to the vulnerable person.

Referring to FIG. 11, when the RCA operation is set to Mode 3, and even when the vulnerable person is seated in the second row, the rear collision direction is determined by considering the positions of the vulnerable person and the passenger seated in the third row even. Therefore, the center C of the rear bumper, which may simultaneously reduce the collision damage of the vulnerable person seated at L2 and the passenger seated at R3, is determined as the rear collision direction.

When the ego vehicle 10 is controlled to collide with the left side L or the right side R of the rear bumper, there is an advantageous effect in the rear collision damage may be reduced more than when the rear collision direction is the center C of the rear bumper. The reason is as follows. The ego vehicle 10 is guided to rotate by guiding the rear vehicle 20 to collide with the left side L or the right side R of the rear bumper of the ego vehicle 10. In this manner, some of collision energy are converted into rotational energy, and an impact amount on the passengers is reduced in the event of the rear collision.

When the collision between the ego vehicle and the rear vehicle is predicted, the RCA device 100 not only determines the rear collision direction but also determines (in the operation S240) the acceleration amount of the ego vehicle which may avoid the rear collision or may minimize the rear collision damage.

The RCA device 100 may determine the acceleration amount of the ego vehicle to avoid the rear collision or to minimize the rear collision damage, based on driving information of the ego vehicle 10, the rear vehicle 20, and/or the front vehicle.

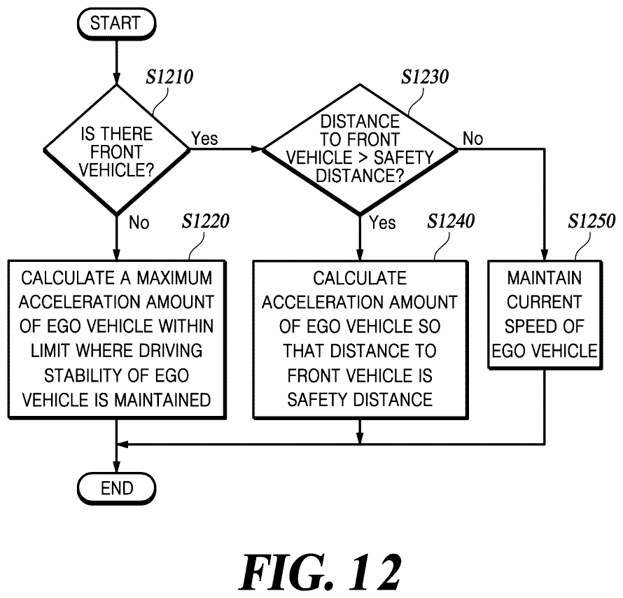

FIG. 12 is a flowchart illustrating a process for the RCA device 100 to determine the acceleration amount of the ego vehicle according to an embodiment of the present disclosure.

In an operation S1210, the RCA device 100 determines whether there is a front vehicle in front of the ego vehicle 10 by using one or more sensors attached to the ego vehicle 10. The reason for checking whether or not there is the front vehicle is to prevent the ego vehicle from colliding with a front obstacle when the ego vehicle is accelerated to avoid the collision with the rear vehicle. In an embodiment, the front vehicle is only an example of the front obstacle, and the RCA device 100 may set any object on a road which has a possibility of a front collision, as a determination target.

When there is no front vehicle in front of the ego vehicle 10 (NO in the operation S1210), a maximum acceleration amount of the ego vehicle 10 is calculated within a limit where driving stability of the ego vehicle 10 is maintained in an operation S1220. For example, when the ego vehicle 10 is driven on a road having a large curvature, there is a risk that the vehicle may be slipped or overturned when the vehicle is accelerated. Therefore, the RCA device 100 calculates the maximum acceleration amount of the ego vehicle 10 by considering the curvature of the road. When there is the front vehicle in front of the ego vehicle 10 (YES in the operation S1210), the RCA device 100 compares a distance to the front vehicle, which is a distance between the front bumper of the ego vehicle 10 and the rear bumper of the front vehicle, with a safe distance (e.g., a preset safe distance) in an operation S1230. In an embodiment, the safe distance means a minimum distance between the ego vehicle 10 and the front vehicle to prevent the ego vehicle 10 from colliding with the front vehicle.

When the distance to the front vehicle is longer than the safe distance (YES in the operation S1230), the RCA device 100 calculates the acceleration amount of the ego vehicle 10, which adjusts the distance to the front vehicle to be equal to the safe distance in an operation S1240. Mathematical expression 2 may be used for calculating acceleration amount of the ego vehicle 10, which adjusts the distance to the front vehicle not to be shorter than the safe distance while speed control is performed to prevent or minimize the rear collision damage.

$$Δ {a}_{ego} = \frac{2 ( {d}_{front} - {d}_{safe} )}{{{T}_{C}}^{2}} + \frac{2 ( {v}_{front} - {v}_{ego} )}{{T}_{C}} + ( {a}_{front} - {a}_{rgo} ) \qquad Mathematical Expression 2$$

In mathematical expression 2, Δa_{ego} represents the acceleration amount of the ego vehicle. d_{front} is a current distance to the front vehicle, and d_{safe} is the safe distance between the ego vehicle and the from vehicle. v_{front} is a current speed of the front vehicle, and v_{ego} is a current speed of the ego vehicle 10. a_{front} is the current acceleration of the front vehicle, and a_{ego} is the current acceleration of the ego vehicle 10. T_{C} represents the length of time during which speed control is performed to prevent or minimize the rear collision damage. Mathematical Expression 2 is calculated under a constant acceleration condition, based on each of the current speed and acceleration of the ego vehicle 10 and the front vehicle.

When the distance to the front vehicle is equal to or shorter than the safe distance (NO in the operation S1230), the acceleration amount of the ego vehicle 10 is not calculated, and the current speed of the ego vehicle 10 is maintained in an operation S1250. The reason is to prevent the ego vehicle 10 from first colliding with the front vehicle due to acceleration control for reducing the rear collision damage.

The RCA device 100 or the autonomous driving system performs steering control and speed control in the operation S250, based on the rear collision direction determined in the operation S230 and the ego vehicle acceleration amount determined in the operation S240.

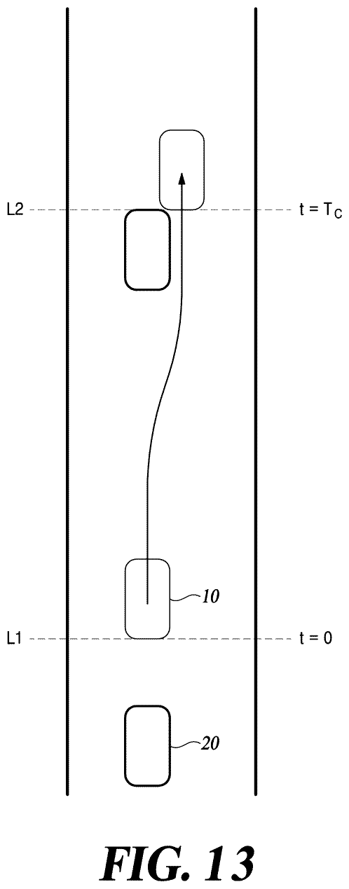

FIGS. 13-15 are diagrams illustrating an example in which driving control is performed in various example situations by the RCA device according to embodiments of the present disclosure.

FIG. 13 is a diagram illustrating an example in which a direction for minimizing the collision damage is the left side L of the rear bumper and there is no front vehicle 30 in a situation where the collision with the rear vehicle 20 is expected. In FIG. 13, a dotted line L1 indicates a position of the rear bumper of the ego vehicle 10 at a time t=0, and a dotted line L2 indicates the position of the rear bumper of the ego vehicle 10 at a driving control completion time t=TC.

The RCA device 100 or the autonomous driving system controls the ego vehicle 10 to be driven in a rightward biased-direction to avoid the collision with the rear vehicle 20 or to minimize the rear collision damage. As a result, even when the ego vehicle 10 and the rear vehicle 20 collide with each other at the driving control completion t=TC, damage to the passengers seated in the last row of the ego vehicle 10 may be minimized.

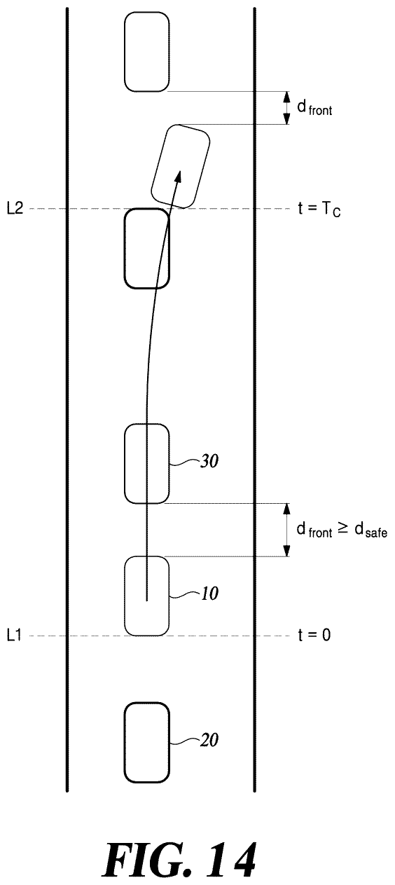

FIG. 14 is a diagram illustrating an example in which the direction for minimizing the collision damage is the left side L of the rear bumper and the distance d_{front} to the front vehicle 30 is longer than the safe distance d_{safe} in a situation where the collision with the rear vehicle 20 is expected. In FIG. 14, the dotted line L1 indicates the position of the rear bumper of the ego vehicle 10 at the current time t=0, and the dotted line L2 indicates the position of the rear bumper of the ego vehicle 10 at the driving control completion time t=TC.

Since the distance d_{front} to the front vehicle is longer than the safe distance d_{safe}, the RCA device 100 calculates the acceleration amount of the ego vehicle 10 which may narrow the distance between the ego vehicle 10 and the front vehicle 30 to be the safe distance d_{safe}. The RCA device 100 or the autonomous driving system controls the ego vehicle 10 to be driven in the rightward-biased direction, based on the calculated acceleration amount of the ego vehicle. As a result, even when the ego vehicle 10 and the rear vehicle 20 collide with each other at the driving control completion time t=TC, damage to the passengers seated in the last row of the ego vehicle 10 may be minimized, and the collision with the front vehicle 30 may be prevented.

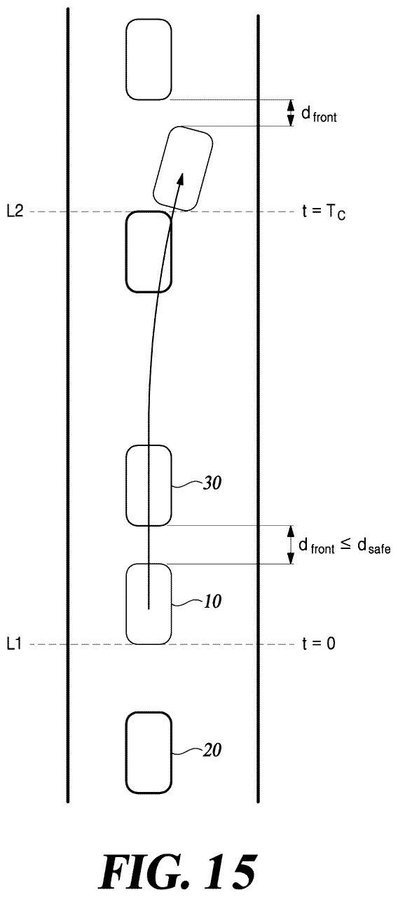

FIG. 15 is a diagram illustrating an example in which the direction for minimizing the collision damage is the left side L of the rear bumper and the distance d_{front} to the front vehicle 30 is equal to or shorter than the safe distance d_{safe} in a situation where the collision with the rear vehicle 20 is expected. In FIG. 15, the dotted line L1 indicates the position of the rear bumper of the ego vehicle 10 at the current time t=0, and the dotted line L2 indicates the position of the rear bumper of the ego vehicle 10 at the driving control completion time t=TC.

Since the distance d_{front} is equal to or shorter than the safe distance d_{safe}, the RCA device 100 or the autonomous driving system controls the ego vehicle 10 to be driven in the rightward biased-direction to the right while maintaining the current speed of the ego vehicle 10. In this case, the RCA device 100 or the autonomous driving system only performs the steering control. As a result, even when the ego vehicle 10 and the rear vehicle 20 collide with each other at the driving control completion time t=TC, damage to the passengers seated in the last row of the ego vehicle 10 may be minimized, and the collision with the front vehicle 30 may be prevented.

In an embodiment, the driving control of the ego vehicle 10 may be performed by following a path profile generated based on the current speed and the current acceleration of the ego vehicle 10, the rear collision direction, and the acceleration amount of the ego vehicle. For example, the length of the path profile may be 4 seconds, but is not limited thereto. In addition, the path profile may be in a form of a third-order polynomial, but is not limited thereto.

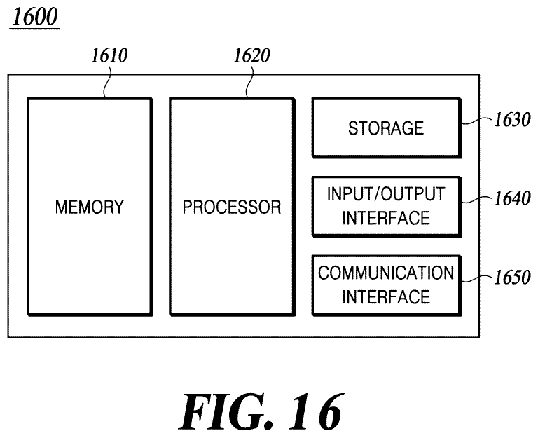

FIG. 16 is a block diagram schematically illustrating a computing device that may be used to implement a method or an apparatus according to embodiments of the present disclosure.

A computing device 1600 may include some or all of a memory 1610, a processor 1620, a storage 1630, an input/output interface 1640, and a communication interface 1650. The computing device 1600 may structurally and/or operationally include at least a portion of the device according to the present disclosure. The computing device 1600 may be not only a stationary computing device such as a desktop computer and a server, but also a mobile computing device such as a laptop computer, a smart phone, and an automotive electronic device. The computing device 1600 may be implemented as any specialized hardware accelerator capable of efficiently processing operations for an artificial intelligence model. For example, the computing device 1600 may include a graphic processing unit (GPU), a tensor processing unit (TPU), or a neural processing unit (NPU).

The memory 1610 may store a program that causes the processor 1620 to perform a method or an operation according to various embodiments of the present disclosure. For example, the program may include a plurality of commands executable by the processor 1620, and the method or the operation may be performed by causing the processor 1620 to execute the plurality of commands. The memory 1610 may be a single memory or a plurality of memories. In this case, information required for performing the method or the operation according to various embodiments of the present disclosure may be stored in the single memory, or may be divided and stored in the plurality of memories. When the memory 1610 includes the plurality of memories, the plurality of memories may be physically separated. The memory 1610 may include at least one of a volatile memory and a nonvolatile memory. The volatile memory includes a static random access memory (SRAM) or a dynamic random access memory (DRAM), and the nonvolatile memory includes a flash memory.

The processor 1620 may include at least one core capable of executing at least one command. The processor 1620 may execute commands stored in the memory 1610. The processor 1620 may be a single processor or a plurality of processors.

The storage 1630 maintains stored data even when power supplied to the computing device 1600 is cut off. For example, the storage 1630 may include the nonvolatile memory, and may include a storage medium such as a magnetic tape, an optical disk, and a magnetic disk. A program stored in the storage 1630 may be loaded into the memory 1610 before being executed by the processor 1620. The storage 1630 may store a file written in a program language, and a program generated from the file by a compiler or the like may be loaded into the memory 1610. The storage 1630 may store data to be processed by processor 1620 and/or data processed by processor 1620.

The input/output interface 1640 may provide an interface with an input device such as a keyboard and a mouse and/or an output device such as a display device and a printer. A user may trigger execution of a program in the processor 1620 through the input device and/or may check a processing result of the processor 1620 through the output device.

The communication interface 1650 may provide access to an external network. The computing device 1600 may communicate with other devices via the communication interface 1650.

Each element of the apparatus or method in accordance with the present disclosure may be implemented in hardware or software, or a combination of hardware and software. The operations of the respective elements may be implemented in software, and a microprocessor may be implemented to execute the software operations corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an illustrative description of the technical idea of the present disclosure. In other words, those having ordinary skill in the art to which the present disclosure pertains may appreciate that various modifications and changes can be made without departing from essential features of an embodiment of the present disclosure. For example, the sequence illustrated in the flowcharts/timing charts can be changed and/or one or more operations of the operations can be performed in parallel. Thus, flowcharts/timing charts are not limited to the temporal order.

Although example embodiments of the present disclosure have been described for illustrative purposes, those having ordinary skill in the art should appreciate that various modifications, additions, and substitutions are possible, without departing from the idea and scope of the present disclosure. Therefore, example embodiments of the present disclosure have been described for the sake of brevity and clarity. The scope of the technical idea of the present disclosure is not limited by the illustrations. Accordingly, one of ordinary skill should understand that the scope of the present disclosure is not to be limited by the above explicitly described embodiments but by the claims and equivalents thereof.

What is claimed is:

1. A computer-implemented method for rear collision-avoidance assist (RCA) for preventing or minimizing rear collision damage of a vehicle, the method comprising:
receiving, by a processor, current driving information of the vehicle and current driving information of a rear vehicle obtained by using at least one sensor included in the vehicle, wherein the current driving information of the vehicle includes a speed and acceleration of the vehicle, and wherein the current driving information of the rear vehicle includes i) a speed and acceleration of the rear vehicle and ii) a distance between the vehicle and the rear vehicle;
determining, by the processor, whether the vehicle and the rear vehicle are predicted to collide with each other within a preset threshold time, based on the current driving information of the vehicle and the current driving information of the rear vehicle;
determining, by the processor, a rear collision direction, based on seating positions including multiple rows of one or more passengers seated in the vehicle;
determining, by the processor, an acceleration amount of the vehicle to prevent a collision between the vehicle and the rear vehicle or to mitigate a rear impact amount, based on the current driving information of the vehicle; and
controlling, by the processor, driving of the vehicle based on at least one of the rear collision direction or the acceleration amount to prevent the collision between the vehicle and the rear vehicle or to mitigate the rear impact amount.

2. The computer-implemented method of claim 1, further comprising:
checking settings of an RCA operation before receiving the current driving information of the vehicle and the current driving information of the rear vehicle,
wherein the RCA operation is set to one of a plurality of modes, the plurality of modes including
a mode 0 in which the RCA operation is deactivated,
a mode 1 in which rear-seat passenger protection for protecting passengers seated in seats other than a driver seat and a front passenger seat is activated, and
a mode 2 in which the rear-seat passenger protection and vulnerable first protection operation for preferentially protecting a vulnerable person in the passengers are activated.

3. The computer-implemented method of claim 2, wherein the vulnerable person includes a child, an elderly person, or a pregnant woman.

4. The computer-implemented method of claim 2, wherein default setting of the RCA operation is the mode 1.

5. The computer-implemented method of claim 2, further comprising, when the RCA operation is set to the mode 0, switching the RCA operation to the mode 1 or the mode 2 based on determining that a passenger is seated at a rear seat of the vehicle.

6. The computer-implemented method of claim 2, wherein, based on determining that the RCA operation is set to the mode 1, determining the rear collision direction includes:
determining a left side of a rear bumper of the vehicle as the rear collision direction, based on determining that there is no passenger seated at a left seat of a last row of the vehicle;
determining a right side of the rear bumper of the vehicle as the rear collision direction, based on determining that there is no passenger seated at a right seat of the last row of the vehicle; and
determining a center of the rear bumper of the vehicle as the rear collision direction, based on determining that there are passengers seated at both the left seat of the last row and the right seat of the last row.

7. The computer-implemented method of claim 6, wherein, based on determining that there is no passenger seated in the last row of the vehicle, determining the rear collision direction includes:
determining the left side of the rear bumper of the vehicle as the rear collision direction, based on determining that there is no passenger seated at a left seat of a middle row of the vehicle;
determining the right side of the rear bumper of the vehicle as the rear collision direction, based on determining that there is no passenger seated at a right seat of the middle row of the vehicle; and
determining the center of the rear bumper of the vehicle as the rear collision direction, based on determining that there are passengers seated at both the left seat of the middle row and the right seat of the middle row.

8. The computer-implemented method of claim 2, wherein based on determining that the RCA operation is set to the mode 2, determining the rear collision direction includes:
determining a left side of a rear bumper of the vehicle as the rear collision direction, based on determining that there is no vulnerable person seated at a left seat of a last row of the vehicle;
determining a right side of the rear bumper of the vehicle as the rear collision direction, based on determining that there is no vulnerable person seated at a right seat of the last row of the vehicle; and
determining a center of the rear bumper of the vehicle as the rear collision direction, based on determining that there is the vulnerable persons seated at both the left seat of the last row and the right seat of the last row.

9. The computer-implemented method of claim 8, wherein based on determining that there is no vulnerable person seated in the last row of the vehicle, determining the rear collision direction includes:
determining the left side of the rear bumper of the vehicle as the rear collision direction, based on determining that there is no vulnerable person seated at the left seat of a middle row of the vehicle;
determining the right side of the rear bumper of the vehicle as the rear collision direction, based on determining that there is no vulnerable person seated at the right seat of the middle row of the vehicle; and
determining the center of the rear bumper of the vehicle as the rear collision direction, based on determining that there are the vulnerable persons seated at both the left seat of the middle row and the right seat of the middle row.

10. The computer-implemented method of claim 1, wherein determining the acceleration amount of the vehicle includes determining a maximum acceleration amount of the vehicle, based on i) a current speed and acceleration of the vehicle and ii) a curvature of a road, based on determining that there is no front vehicle in front of the vehicle.

11. The computer-implemented method of claim 1, wherein determining the acceleration amount of the vehicle includes determining an acceleration amount of the vehicle so that a distance between the vehicle and a front vehicle converges to a safe distance, based on determining that i) there is a front vehicle in front of the vehicle and ii) a distance to the front vehicle is longer than a preset safe distance.

12. The computer-implemented method of claim 1, wherein determining the acceleration amount of the vehicle includes determining the acceleration amount of the vehicle that maintains a distance between the vehicle and a front vehicle, based on determining that i) there is a front vehicle in front of the vehicle and ii) a distance to the front vehicle is equal to or shorter than a preset safe distance.

13. The computer-implemented method of claim 1, wherein controlling driving the vehicle includes controlling an autonomous driving system of the vehicle based on the rear collision direction and the acceleration amount to prevent the collision between the vehicle and the rear vehicle or to mitigate the rear impact amount.

14. A rear collision-avoidance assist (RCA) device for preventing or minimizing rear collision damage of a vehicle, the device comprising:
at least one memory storing computer-executable instructions; and
at least one processor,
wherein the at least one processor is configured to execute the computer-executable instructions to:
receive current driving information of the vehicle and current driving information of a rear vehicle obtained by using at least one sensor included in the vehicle, wherein the current driving information of the vehicle includes a speed and acceleration of the vehicle, and wherein the current driving information of the rear vehicle includes i) a speed and acceleration of the rear vehicle and ii) a distance between the vehicle and the rear vehicle,
determine whether the vehicle and the rear vehicle are predicted to collide with each other within a preset threshold time, based on the current driving information of the vehicle and the current driving information of the rear vehicle,
determine a rear collision direction, based on seating positions including multiple rows of one or more passengers seated in the vehicle,
determine an acceleration amount of the vehicle to prevent a collision between the vehicle and the rear vehicle or to mitigate a rear impact amount, based on the current driving information of the vehicle, and
control driving of the vehicle based on at least one of the rear collision direction or the acceleration amount to prevent the collision between the vehicle and the rear vehicle or to mitigate the rear impact amount.

15. The RCA device of claim 14, wherein the at least one processor is further configured to execute the computer-executable instructions to:
check settings of an RCA operation before receiving the current driving information of the vehicle and the current driving information of the rear vehicle,
wherein the RCA operation is set to one of a plurality of modes, the plurality of modes including
a mode 0 in which the RCA operation is deactivated,
a mode 1 in which rear-seat passenger protection for protecting passengers seated in seats other than a driver seat and a front passenger seat is activated, and
a mode 2 in which the rear-seat passenger protection and vulnerable first protection operation for preferentially protecting a vulnerable person in the passengers are activated.

16. The RCA device of claim 15, wherein default setting of the RCA operation is the mode 1.

17. The RCA device of claim 15, wherein the at least one processor is further configured to execute the computer-executable instructions to, when the RCA operation is set to the mode 0, switch the RCA operation to the mode 1 or the mode 2 based on determining that a passenger is seated at a rear seat of the vehicle.

18. The RCA device of claim 15, wherein the at least one processor is configured to execute the computer-executable instructions to:
based on determining that the RCA operation is set to the mode 1,
determine a left side of a rear bumper of the vehicle as the rear collision direction, based on determining that there is no passenger seated at a left seat of a last row of the vehicle,
determine a right side of the rear bumper of the vehicle as the rear collision direction, based on determining that there is no passenger seated at a right seat of the last row of the vehicle, and
determine a center of the rear bumper of the vehicle as the rear collision direction, based on determining that there are passengers seated at both the left seat of the last row and the right seat of the last row.

19. The RCA device of claim 18, wherein the at least one processor is configured to execute the computer-executable instructions to:
based on determining that there is no passenger seated in the last row of the vehicle,
determine the left side of the rear bumper of the vehicle as the rear collision direction, based on determining that there is no passenger seated at a left seat of a middle row of the vehicle,
determine the right side of the rear bumper of the vehicle as the rear collision direction, based on determining that there is no passenger seated at a right seat of the middle row of the vehicle, and
determine the center of the rear bumper of the vehicle as the rear collision direction, based on determining that there are passengers seated at both the left seat of the middle row and the right seat of the middle row.

20. The RCA device of claim 15, wherein the at least one processor is configured to execute the computer-executable instructions to:
based on determining that the RCA operation is set to the mode 2,
determine a left side of a rear bumper of the vehicle as the rear collision direction, based on determining that there is no vulnerable person seated at a left seat of a last row of the vehicle,
determine a right side of the rear bumper of the vehicle as the rear collision direction, based on determining that there is no vulnerable person seated at a right seat of the last row of the vehicle, and
determine a center of the rear bumper of the vehicle as the rear collision direction, based on determining that there is the vulnerable persons seated at both the left seat of the last row and the right seat of the last row.
